(19) United States
(12) Patent Application Publication
(10) Pub. No.: US 2025/0366668 A1
(43) Pub. Date: Dec. 4, 2025

(54) PLANT-BASED MILK MIXING MACHINE

(71) Applicant: Hamilton Beach Brands, Inc., Glen Allen, VA (US)

(72) Inventors: Michael Allen, Glen Allen, VA (US); Kevin Leppert, Glen Allen, VA (US)

(73) Assignee: Hamilton Beach Brands, Inc., Glen Allen, VA (US)

(21) Appl. No.: 18/677,300

(22) Filed: May 29, 2024

(51) Int. Cl. A47J 43/07; A47J 43/044; B65D 1/02; B65D 23/10; B67D 1/00; B67D 1/08

(52) U.S. Cl. CPC A47J 43/0716; A47J 43/044; A47J 43/0727; B65D 1/0223; B65D 23/10; B67D 1/0001; B67D 1/0888; A47J 2043/0449; B65D 2501/0081; B67D 2210/0012; B67D 2210/00144; B67D 2210/0016

(57) ABSTRACT

A beverage mixing machine includes: a base; a tower extending upwardly from the base, the tower including a main portion and an overhanging portion; a dispensing outlet located in the overhanging portion; one or more sensors located near the dispensing outlet, the one or more sensors configured to detect the presence of a magnet; and a controller mounted in one of the base and the tower, the controller operatively connected with the sensors, the controller configured to prevent operation of the machine unless at least one of the one or more sensors detect the presence of a magnet.

### FIELD

The present application relates to a system and method for dispensing and mixing a food and beverage product and, more particularly, to a system and method for dispensing and mixing a plant-based food and beverage product.

### BACKGROUND

In recent years, consumption of plant-based or non-dairy milk alternatives has significantly increased. Nowadays, cow milk allergy, lactose intolerance, calorie concern, and preference for vegan diets have influenced consumers towards choosing cow milk alternatives. Additionally, people may prefer non-dairy alternatives due to concerns over saturated fat levels, hormone content, and antibiotic use in dairy cattle. Plant-based beverages may be derived, for example, from soy, various nuts, or grains. Many retail plant-based products (e.g., almond-milk, cashew-milk, etc.) have numerous synthetic ingredients added to achieve a level of sterility for commercial distribution and retail sale. Additionally, retail products can have up to 20 ingredients such as gums, thickeners, vitamin packs, and preservatives that are added to this perishable liquid product to achieve an appealing taste, texture, color, etc., and to maintain that for commercially acceptable shelf life.

The commercial processes used to make commercial plant-based milk, such as nut milk, often occur at high heat (e.g., 135° C./275° F.). This type of processing can cause degradations in flavor, color, and the smell of the milk. Also, a factor that drives up the cost of commercially distributed nut milk is the fact that they are water-based and must be refrigerated.

Making pure (“clean”) plant-based beverages without preservatives is also challenging. These beverages usually contain only a few ingredients (e.g., nuts/nut paste and water) and may be too perishable to be sold through a distribution chain. Moreover, although the plant-based ingredients alone may not be perishable and can be stored at room temperature, those ingredients can become highly perishable once commercially processed with various liquids (e.g., water). Even the preservative-laced milk products may not last over a week in a consumer's refrigerator due to transit times in distribution and the time the product sits on a retail shelf before purchase.

Plant-based milk (e.g., almond milk) can be made in different ways. For example, plant-based milk can be produced by mixing plant-based powder (i.e., ground nuts) with other desired ingredients, such as water, spices, other flavorings, sweeteners, etc. Plant-based milk can alternatively be produced by mixing predetermined quantities of plant-based paste with other desired ingredients. Each technique for producing plant-based milk poses distinct challenges owing, in part, to the physical differences between plant-based powder and plant-based paste. For example, unlike plant-based powder, which typically has a dry, granular consistency, plant-based paste typically has a more fluidlike or pasty consistency caused by the release of natural oils from plant-based material during pulverization. These natural oils can “separate” from the more solid constituents of the plant-based paste over time, resulting in the formation of separate layers of different constituent materials in a packaged plant-based paste.

One system for making and dispensing plant-based milk is described in U.S. Pat. No. 11,547,975 to Suh et al., the disclosure of which is hereby incorporated herein by reference. The system is configured to dispense a plant-based paste into a vessel, then mix the paste with water. Other documents that may describe aspects of the system include U.S. Pat. Nos. 11,419,518 and 11,541,364 and U.S. Patent Publication Nos. 2023/0276992; 2021/0387842; 2021/0284417; 2020/0254409; and 2018/0035841, each of which is hereby incorporated by reference herein in full. It may be desirable to provide improved aspects to such a system.

### SUMMARY

As a first aspect, embodiments of the invention are directed to a bottle for a beverage mixing machine. The bottle comprises: a floor; at least one side wall extending upwardly from the floor; and a neck extending upwardly from the side wall. The neck includes at least one magnet at least partially embedded therein.

As a second aspect, embodiments of the invention are directed to a beverage mixing machine comprising: a base; a tower extending upwardly from the base, the tower including a main portion and an overhanging portion; a dispensing outlet located in the overhanging portion; one or more sensors located near the dispensing outlet, the one or more sensors configured to detect the presence of a magnet; and a controller mounted in one of the base and the tower, the controller operatively connected with the sensors, the controller configured to prevent operation of the machine unless at least one of the one or more sensors detect the presence of a magnet.

As a third aspect, embodiments of the invention are directed to a beverage mixing machine comprising: a base; a tower extending upwardly from the base, the tower including a main portion and an overhanging portion; a pouch chamber with a dispensing outlet located in the overhanging portion, the pouch chamber at least partially defined by first and second pressing plates; a piston mounted in the tower that engages the first pressing plate, the piston configured to move the first pressing plate toward the second pressing plate to squeeze contents of a pouch residing in the pouch chamber through the dispensing outlet; first and second sensors located adjacent the pouch chamber at, respectively, first and second heights, the first and second sensors configured to detect the presence of a pouch in the pouch chamber; a controller mounted in one of the base and the tower, the controller operatively connected with the first and second sensors and the piston, the controller configured to prevent activation of the piston if the first and second sensors detect a pouch of an incorrect size.

### BRIEF DESCRIPTION OF THE FIGURES

FIG. 1 is a perspective view of a plant-based beverage mixing machine and bottle according to embodiments of the invention.

FIG. 2 is a perspective view of the machine of FIG. 1 without the bottle present.

FIG. 3 is a partial bottom perspective view of the machine of FIG. 1 showing the motor, belt, and drive train for mixing.

FIG. 4 is a partial top perspective view of the base of the machine in FIG. 1 showing the clutch hub.

FIG. 5 is a partial side section view of the drive train and clutch hub of the machine of FIG. 1.

FIG. 6 is a side section view of the drivetrain and clutch hub of FIG. 5 engaged with the stirrer of the bottle.

FIG. 7 is a top perspective view of the bottle of FIG. 1.

FIG. 8 is a top perspective view of the upper portion and neck of the bottle of FIG. 7, wherein the neck is shown as transparent so that the magnets embedded therein are visible.

FIG. 9 is a front perspective view of the bottle of FIGS. 7 and 8 in position in the machine of FIG. 1, wherein part of the overhanging portion has been removed so that the sensor mounted therein is visible.

FIG. 10 is a side section view of the overhanging portion of the machine of FIG. 1 showing the door in its closed position and the pressure plates forced together.

FIG. 11 is a rear side perspective section view of the machine of FIG. 1 showing the piston engaging the rear pressure plate.

FIG. 12 is a rear side perspective section view of the machine of FIG. 1 showing the location of the controller.

FIG. 13 is a perspective view of a pouch to be used with the machine of FIG. 1.

FIG. 14 is a side view of the machine of FIG. 1 with the door shown in its open position.

FIG. 15 is a partial cutaway side view of the machine of FIG. 1 with the door in its open position.

FIG. 16 is a partial cutaway side view of the machine of FIG. 1 with the door in its open position and a pouch inserted into the pouch chamber.

FIG. 17 is a perspective view of a plant-based beverage mixing machine according to additional embodiments of the invention, showing a large bottle in position in the machine and showing separately a smaller bottle that may also be employed with the machine.

FIG. 18 is a perspective view of the smaller bottle of FIG. 17.

FIG. 19 is a perspective view of the larger model of FIG. 17.

FIG. 20 is a partial top perspective view of the neck of the smaller bottle of FIG. 18, with the neck shown as transparent so that the magnets embedded therein are visible.

FIG. 21 is a partial top perspective view of the neck of the larger bottle of FIG. 19, with the neck shown as transparent so that the magnets embedded therein are visible.

FIG. 22 is a partial bottom perspective view of the skirt of the overhanging portion of the machine of FIG. 17.

FIG. 23 is a partial front perspective view of the skirt of FIG. 22 showing sensors embedded therein.

FIG. 24 is a perspective view of the front pressure plate of the machine of FIG. 17.

FIG. 25 is a partial top perspective view of the machine of FIG. 17 with the door in its open position.

FIG. 26 is a partial top perspective view of the machine of FIG. 17 with the door in its open position and a pouch being inserted into the pouch chamber.

FIG. 27 is a side view of the pressure plates of the machine of FIG. 17 showing the positions of the optical sensors used to detect the presence and size of a pouch.

FIG. 28 is a top perspective view of the pressure plates of the machine of FIG. 17 showing the optical sensors.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

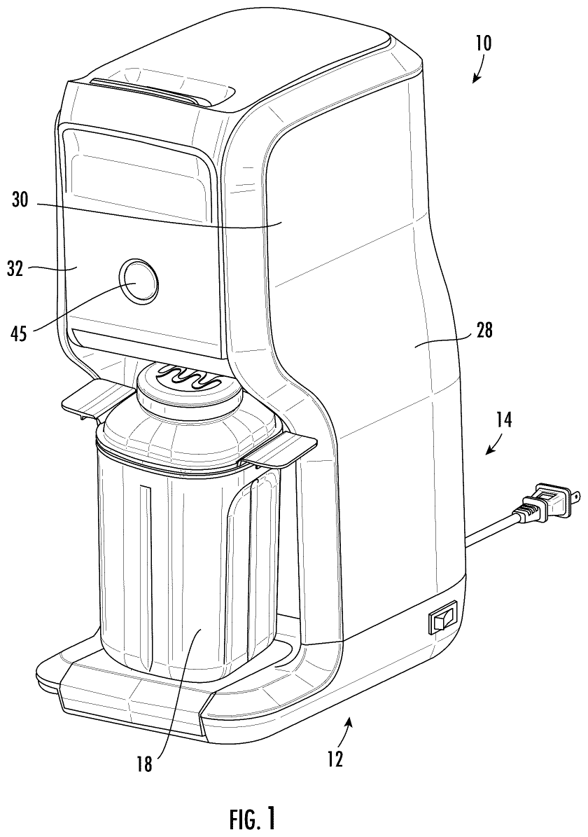

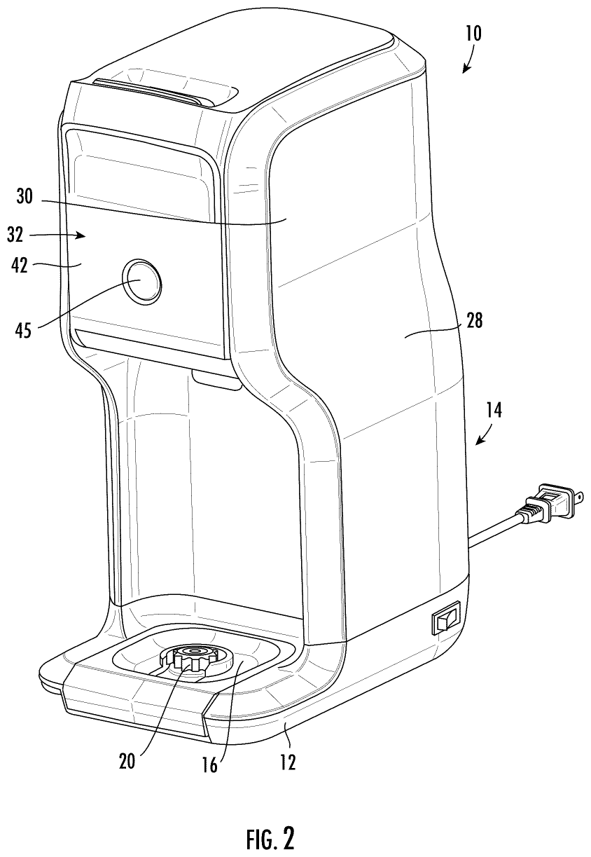

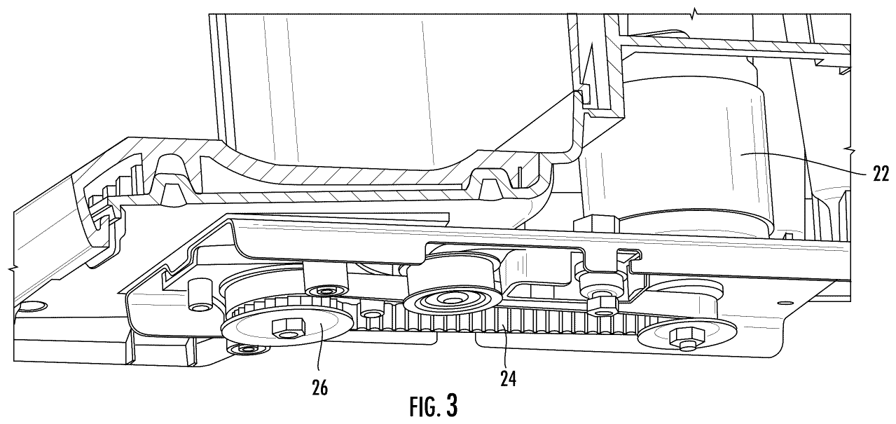

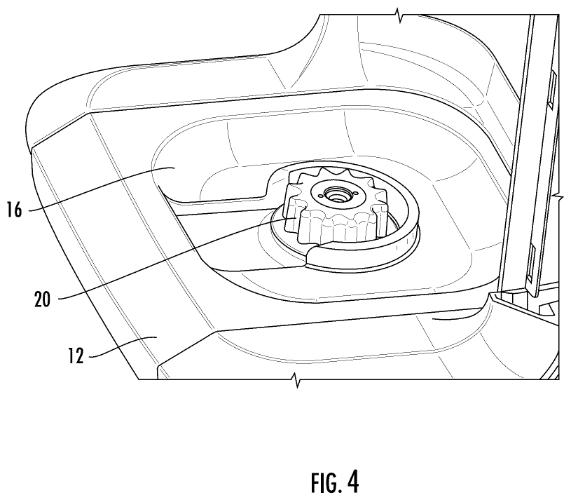

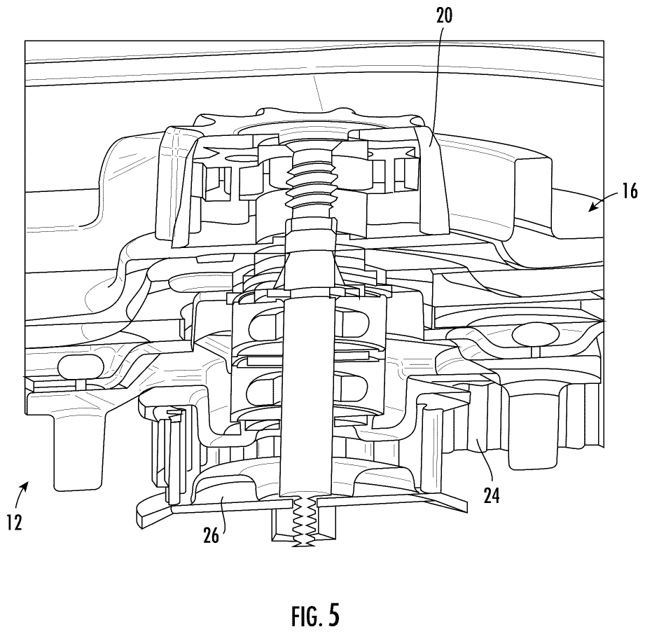

Referring now to the drawings, a plant-based milk dispensing machine, designated broadly at 10, is shown in FIGS. 1 and 2. The machine 10 incudes a base 12 and a tower 14 that extends vertically upwardly from a rear portion of the base 12. The base 12 includes a receiving recess 16 on which a bottle 18 rests during operation. A toothed clutch hub 20 is rotatably mounted within the receiving recess 16 (FIGS. 3 and 4). The clutch hub 20 is operatively connected with a motor 22 (located in the tower 14—see FIG. 3) via a belt 24 that engages a drive train 26 positioned below the recess 16 (FIGS. 4 and 5). The drive train 26 (FIG. 3) is connected via a common shaft with the clutch hub 20.

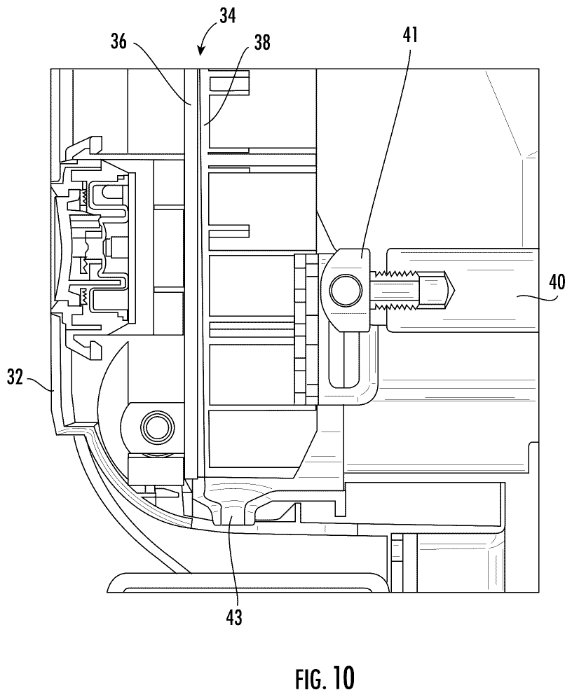

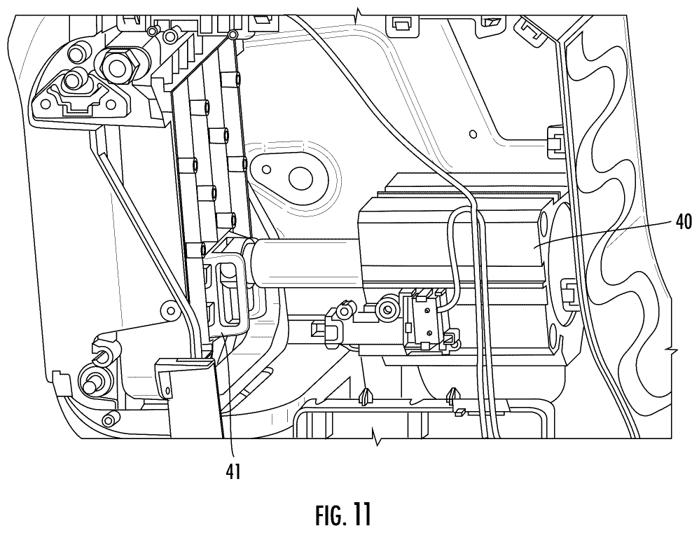

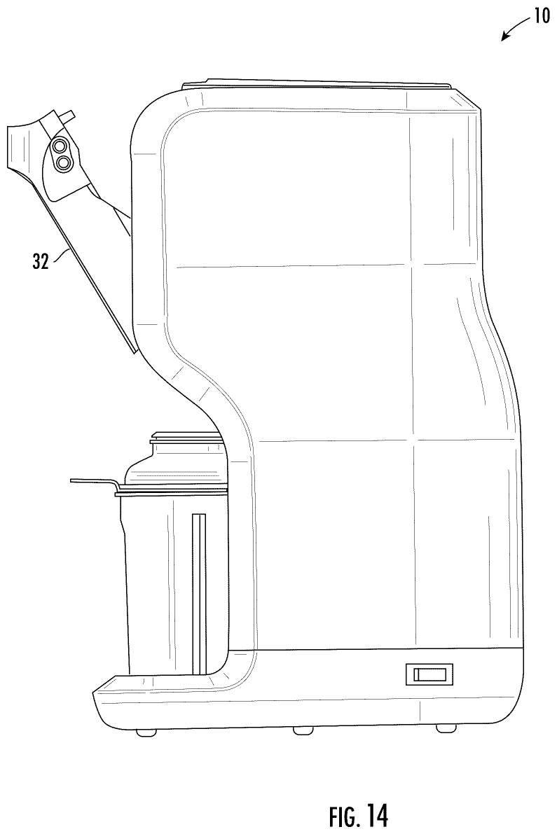

Referring back to FIGS. 1 and 2, the tower 14 includes a main portion 28 and an overhanging portion 30 that overhangs the recess 16. A door 32 is pivotally attached to the lower front end of the overhanging portion 30. As shown in FIGS. 1 and 14-16, the door 32 can pivot between an open position (FIGS. 14-16), in which a user has access to a pouch chamber 34, and a closed position (FIG. 1), in which the pouch chamber 34 is enclosed. The pouch chamber 34 is defined partially by two pressing plates 36, 38 (FIGS. 10, 11, 15 and 16); the pressing plate 36 is attached to and pivots with the door 32, and the pressing plate 38 is attached within the overhanging portion 30. A piston 40 (FIGS. 10 and 11) is mounted within the main portion 28 of the tower 14 and is positioned to engage the pressing plate 38 through a bracket 41 attached to the forward end of the piston 40. An outlet 43 is present at the lower end of the pouch chamber 34 (FIG. 10).

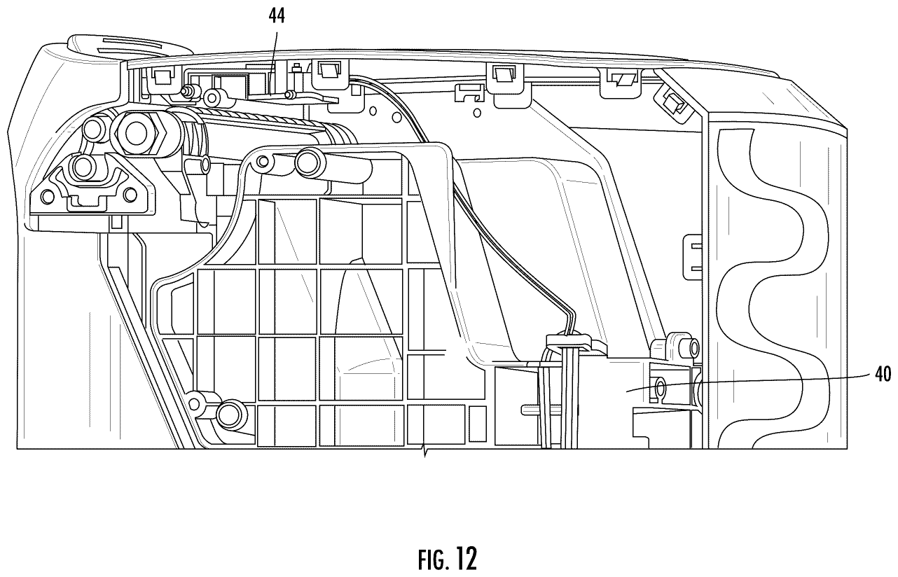

A control panel 42 (FIG. 2) is located on the door 32, which includes one or more activation buttons 45. The control panel 42 is operatively connected with a controller (in this embodiment, the controller is in the form of a PCB 44—see FIG. 12) that controls the operation of the machine 10. The controller 44 is also operatively connected with the piston 40 and the motor 22.

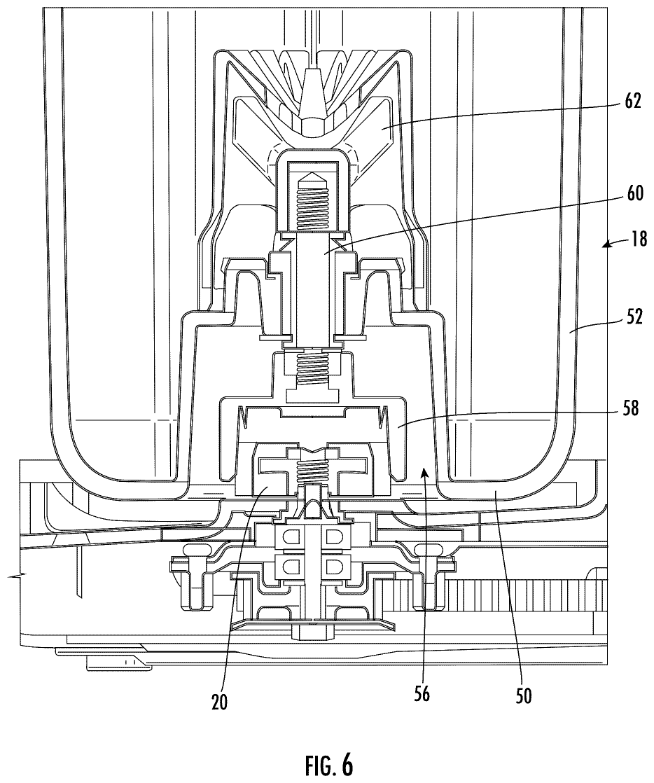

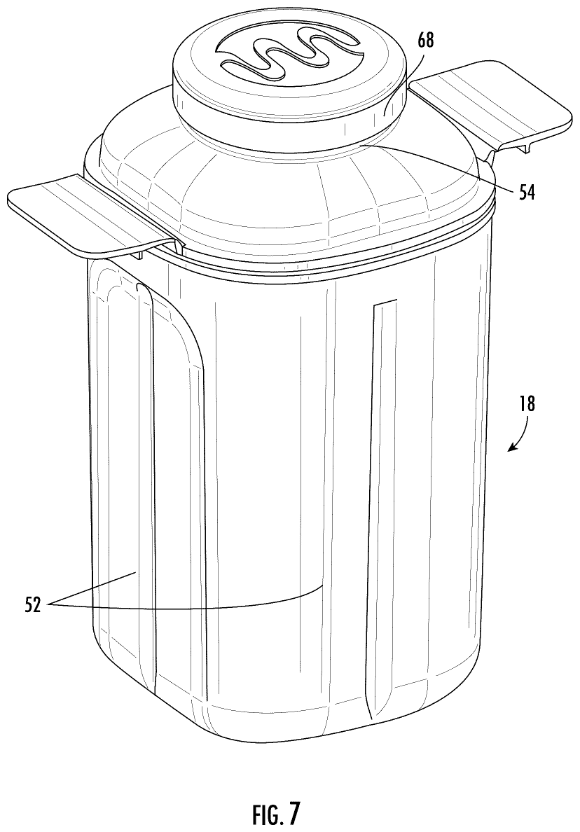

Referring now to FIGS. 6-8, the bottle 18 is shown therein. The bottle 18 has a floor 50, four side walls 52, and a neck 54 at its upper end. The side walls 52 generally define a square with generously rounded corners. The floor 50 of the bottle 18 include a recess 56 that is sized to receive the clutch hub 20 discussed above. A toothed clutch basket 58 is present in the recess 56 to mate with the clutch hub 20. A stirrer 60 with blades 62 is located above the recess 56, and is connected with the clutch basket 58 via a shaft 64 that extends through a bearing 66 in the recess 56. A lid 68 fits over the neck 54 to seal the top of the bottle 18.

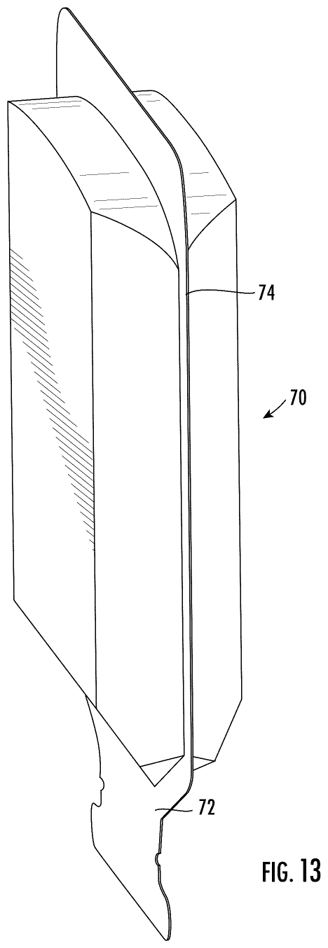

Referring now to FIG. 13, a pouch 70 is shown therein. The pouch 70 is generally rectangular and includes a spout 72 at one end. A lip 74 surrounds the two sides and one end of the pouch 70. The pouch 70 is filled with a paste that represents a concentrate of the beverage to be produced with the machine. Exemplary beverages include oat milk, soy milk, and nut-based milk products like almond milk. Details on the formulations are discussed in detail in, for example, U.S. Patent Publication No. 2019/0344233 to Savino, the disclosure of which is hereby incorporated by reference herein in full.

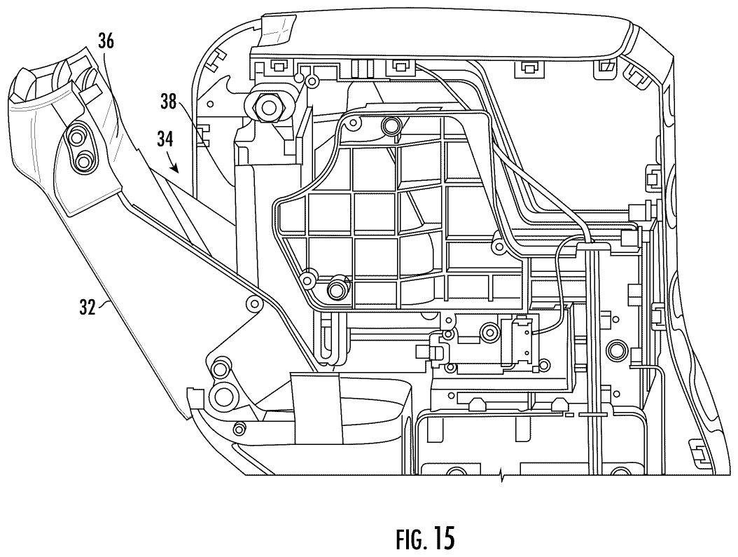

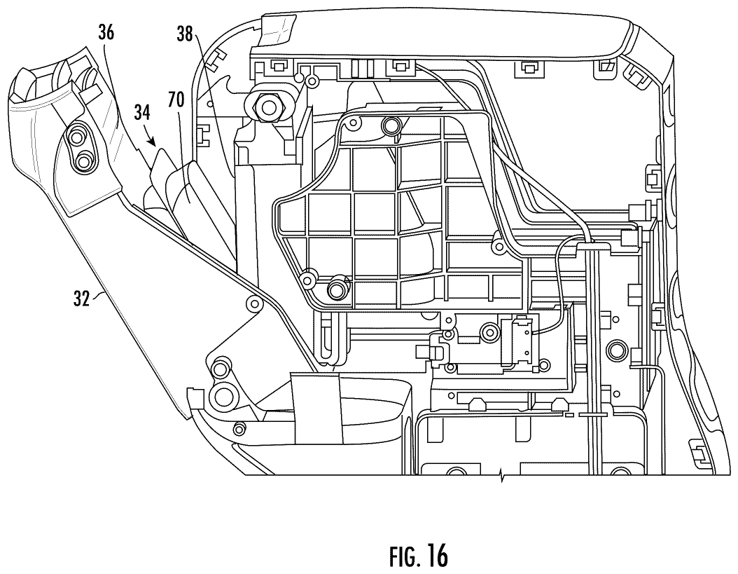

To operate the machine 10, a user pivots the door 32 to the open position of FIGS. 14 and 15, then inserts a pouch 70 into the pouch chamber 34 (FIG. 16) between the pressing plates 36, 38, with the spout 72 having been opened and facing downwardly toward the outlet 43. The user fills the bottle 18 with a prescribed amount of water, then places the bottle 18 into position in the recess 16, such that the clutch basket 58 encloses the clutch hub 20. The recess 16 generally matches the cross-section of the bottle 18 (i.e., the recess 16 is generally a square with generously rounded corners), such that the bottle 18 is seated within the recess 16. The user then pivots the door 32 to the closed position (e.g., FIGS. 1, 10 and 11) to entrap the pouch 70 between the pressing plates 36, 38. The user then activates the machine 10 by pressing one of the activation buttons 45 on the control panel 42. This action signals the controller 44 to cause the piston 40 to extend, which in turn forces the pressing plate 38 forward, thereby squeezing the pouch 70 against the pressing plate 36. The squeezing action forces paste from the pouch 70 through the spout 72 and outlet 43 and into the bottle 18, where the paste contacts the water. The controller 44 also signals the motor 22 to operate, which causes the clutch hub 20 to rotate. Rotation of the clutch hub causes the stirrer 60 to rotate within the bottle 18, thereby mixing the paste from the pouch 70 with the water in the bottle 18. Stirring continues until the contents are thoroughly mixed. The bottle 18 is removed and, in most instances, capped and sealed with the lid 68. The door 32 is moved to the open position and the (mostly) empty pouch 70 is removed.

Further details about the general operation of the machine 10 are discussed in, for example, U.S. Pat. No. 11,547,975 to Suh et al, supra, the disclosure of which is hereby incorporated herein by reference in full.

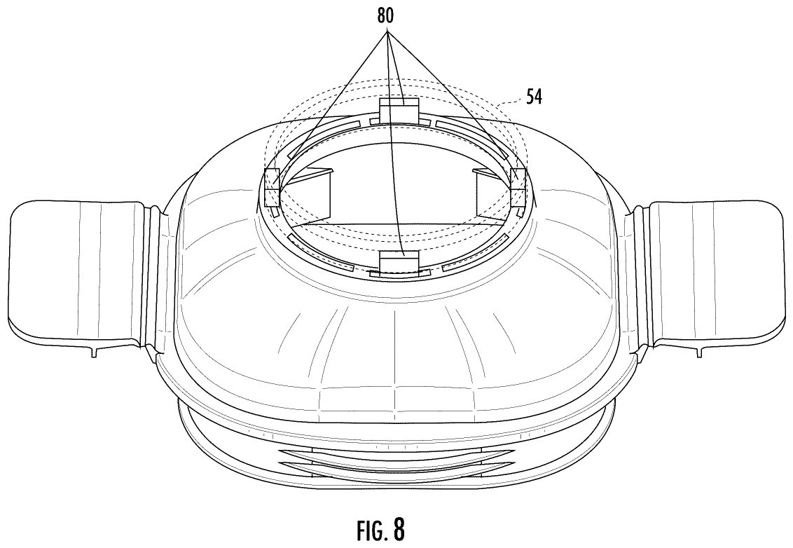

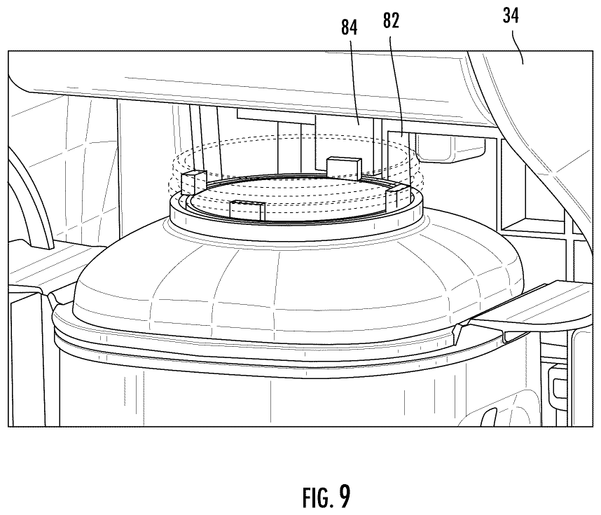

Examining the machine 10 and bottle 70 in greater detail, FIG. 8 illustrates that the neck 54 of the bottle 18 includes four magnets 80. The magnets 80 are distributed substantially circumferentially equidistant from each other around the neck 54 (i.e., they are approximately 90 degrees apart) and are at least partially (and in some instances entirely) embedded in the neck 54. FIG. 9 reveals that a block 82 is positioned such it extends downwardly from the overhanging portion 34 of the tower and extends forwardly from the main portion 32. A sensor 84 (e.g., a Hall sensor) is located within the block 82 and is operatively connected with the controller 44. The location of the sensor 84 positions the sensor 84 adjacent to and behind the neck 54 of the bottle 18 when the bottle 18 is positioned within the recess 16 of the base 12. The magnets 80 are positioned in the neck 54 such that, when the bottle 18 is seated in the recess 16, one of the four magnets 80 is located directly in front of the sensor 84.

The aforementioned configuration can serve as an “interlock” for the machine 10 that prevents the machine 10 from operating if a bottle 10 is not in place. More specifically, if a bottle 18 is present in the recess 16 and therefore positioned to receive paste from a pouch 70, the sensor 84 can detect one of the magnets 80 in the neck 54 of the bottle 18, and can signal the controller 44 that a bottle 18 is present. However, if the sensor 84 does not sense the presence of a magnet 80, the controller 44 understands that no bottle 18 present, and therefore an attempt to activate the machine 10 by pushing the activation button 45 does not initiate operation of the machine 10. Thus, the absence of the detection of a magnet by the sensor 84 causes the controller to prevent operation of the machine 10.

Notably, the presence of four magnets 80 enables the user to orient the bottle 18 in any of four orientations (each at 90 degree intervals) that enable the bottle 18 to fit correctly within the recess 16 and still allow the machine 10 to detect its presence.

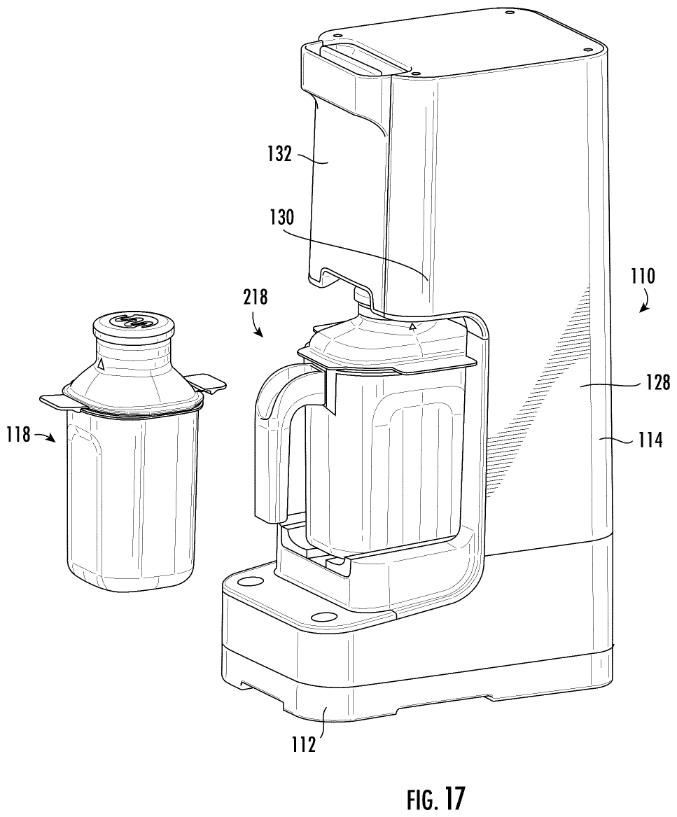

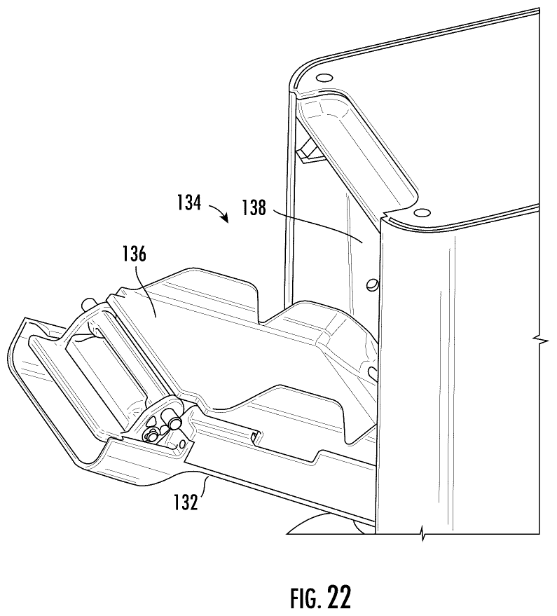

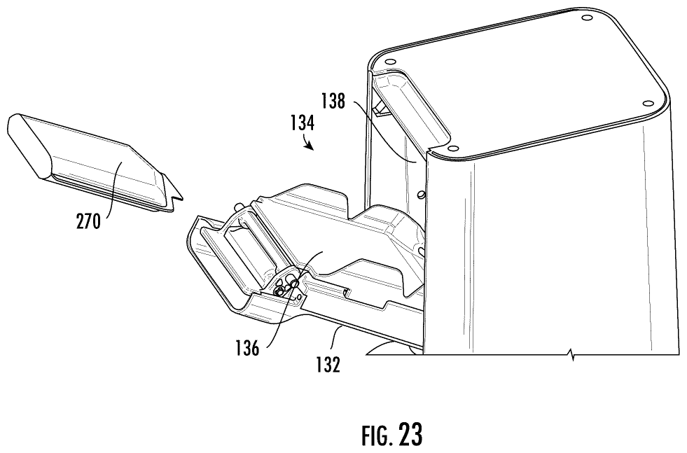

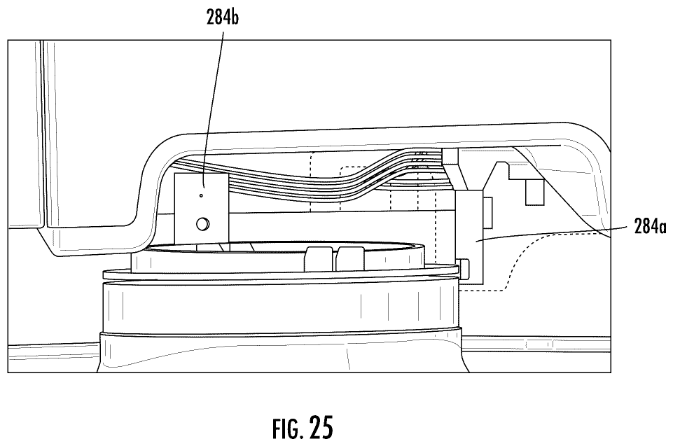

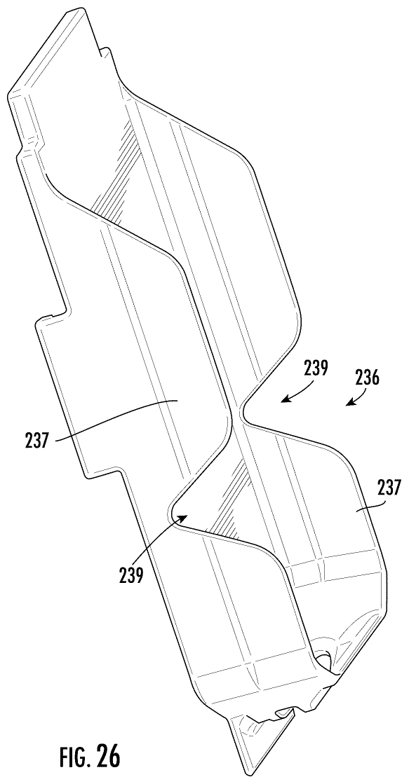

Referring now to FIGS. 17-28, another plant-based milk dispensing machine, designated broadly at 110, is shown therein. The machine 110 is typically deployed in commercial establishments (e.g., coffee shops, restaurants, etc.). The machine 110 is similar in many respects to the machine 10, in that it has a base 112 and a tower 114, wherein the tower 114 has a main portion 128 and an overhanging portion 130. The machine 110 makes a plant-based beverage (e.g., milk) by squeezing paste from a pouch between two pressing plates 136, 138 (FIG. 22) into a bottle residing on the base 112 and mixing the paste with water in the bottle with a stirrer. However, the machine 110 is configured to dispense paste from two different sizes of pouches 170, 270, and is further configured to mix the beverage in either of two different sizes of bottles 118, 218. In addition, instead of the user providing the water in the bottle prior to the dispensing of paste into the bottle from a pouch, the machine itself is configured to convey water into the bottle. These differences, in addition to other distinctions, are discussed below.

Referring now to FIG. 24, a water nozzle 250 is shown therein. As can be seen in FIG. 24, the water nozzle 250 is positioned to dispense water into a bottle 118, 218 when the bottle 118, 218 is positioned on the base 112 for dispensing. The water nozzle 250 is typically fed from a continuous water source (e.g., the nozzle 250 may be connected to a nearby water line), but may also be fed from a refillable reservoir that is attached to the machine 110 (not shown herein). A pump or other conveying device (not shown) conveys water from the source to the water nozzle 250, and a flow meter (not shown) is associated with the water nozzle 250 to monitor the amount of water dispensed into the bottle 118, 218. The pump and flow meter are operatively connected with a controller (not shown, but similar to the controller 44 discussed above).

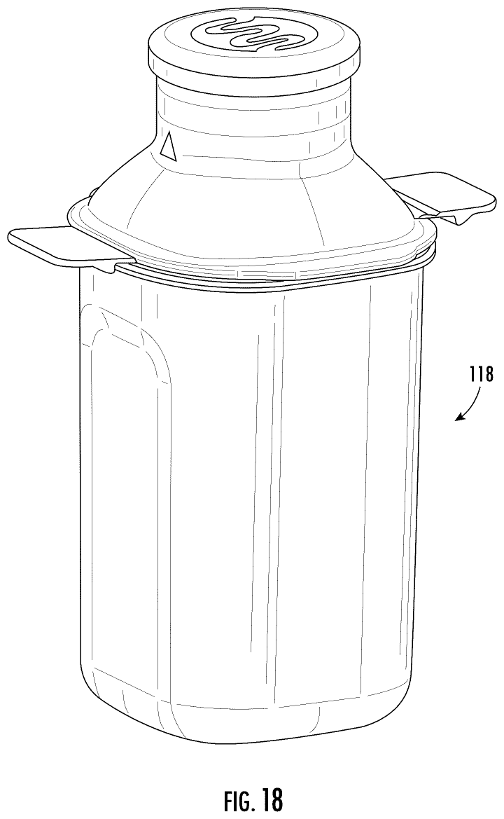

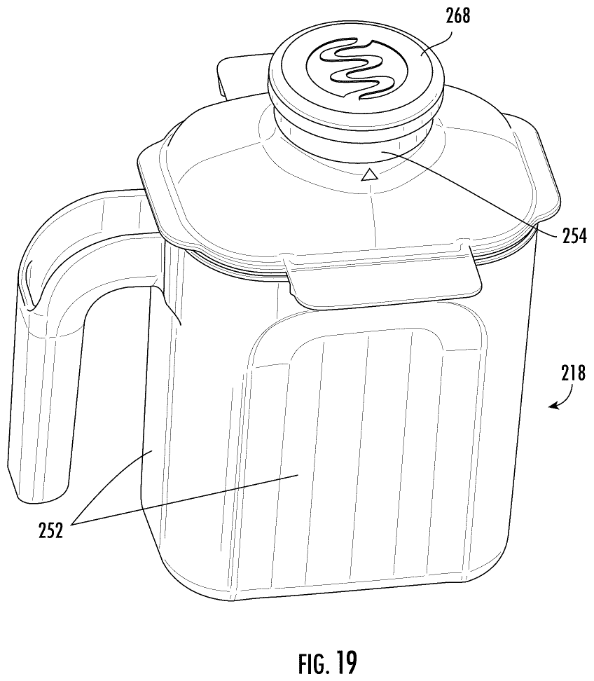

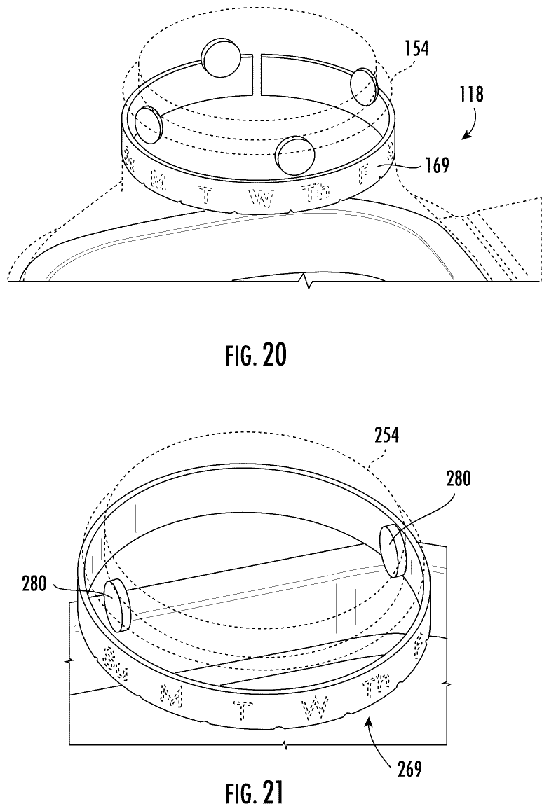

Referring now to FIGS. 18 and 20, the bottle 118 shown therein is similar to the bottle 18 discussed above. The bottle 218 (FIGS. 19 and 21) is similar to the bottles 18, 118 in that it has a floor (not shown), four side walls 252, and a neck 254 at its upper end. Unlike the bottles 18, 118, the four side walls 252 generally define a rectangle (rather than a square) with generously rounded corners. The floor of the bottle 218 include a recess that is sized to receive a clutch hub like that discussed above. A clutch basket is present in the recess to mate with the clutch hub. A stirrer (not shown) similar to that of the bottles 18, 118 is present within the bottle 218. A lid 268 fits over the neck 254 to seal the top of the bottle 218.

Also, as shown in FIG. 21, a ring-shaped indicator 269 encircles the neck 254 and is rotatable relative thereto. The indicator 269 typically includes indicia to indicate a parameter regarding the contents of the bottle 218. For example, the indicia may indicate when a bottle was filled so that a prescribed level of freshness can be ensured, or may indicate the type of milk that is contained in the bottle. In some embodiments, the indicator 269 can interact with ridges or detents (not shown) in the neck 254 so that the indicator 269 is maintained in a desired position. (In some embodiments, the bottle 118 will also include a similar indicator 169 on its neck 154—see FIG. 20).

In addition, the bottle 218 has only two (rather than four) magnets 280 embedded in the neck 254. The magnets 280 are diametrically opposed to each other (i.e., 180 degrees apart) across the neck 254 (FIG. 21).

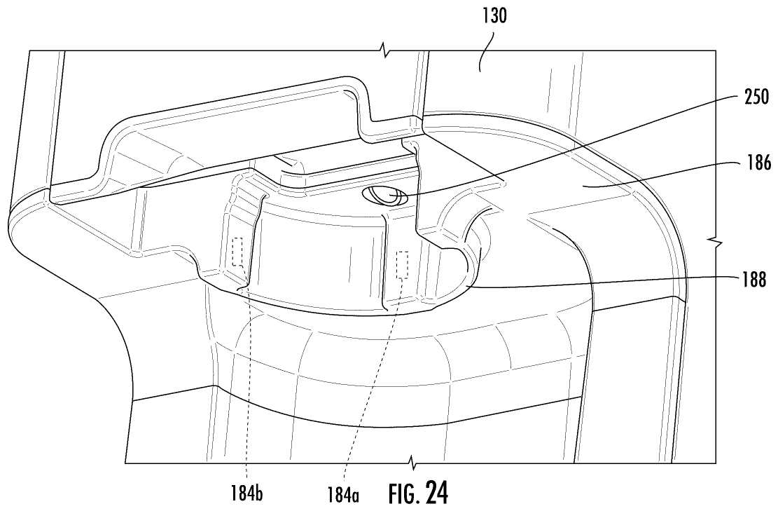

Referring now to FIG. 24, it can be seen that the overhanging portion 130 of the machine 110 includes a lower shell 186 with a semicircular skirt 188. Two sensors 184a, 184b (see FIG. 23) are embedded within the skirt 188, and are separated from each other by 90 degrees, with the sensor 184a being located at the rear of the skirt 188 and the sensor 184b being located near one forward end of the skirt 188. Each of the sensors 184a, 184b is operatively connected with the controller 144.

Because of the differing configurations of the bottles 118, 218, and the deployment of the two sensors 184a, 184b, the machine 110 has the ability to identify which bottle is present for dispensing. The ability to distinguish between the bottles 118, 218 can be important because the machine 118 itself dispenses the water into the bottle 118, 218 (rather than the water being provided by the user), and therefore must dispense the proper amount of water based on the size of the bottle. When a large bottle 218 (which has two diametrically opposed magnets 280 in the neck 254) is positioned for dispensing, only the sensor 184b detects a magnet 180, as there is no magnet adjacent the sensor 184a. As such, the machine 110 identifies the bottle 218 as a large bottle and dispenses water accordingly. The bottle is identified correctly irrespective of the orientation of the bottle 218 (which can be positioned for dispensing in either of two orientations that are 180 degrees apart).

If instead a small bottle 118 is positioned for dispensing, a respective one of the magnets 180 is positioned adjacent to each of the sensors 184a, 184b, with the result that both sensors 184a, 184b sense a magnet 180. The machine 110 therefore identifies the bottle 118 as a small bottle, and dispenses water accordingly. The machine 110 can make the correct determination about bottle size in any of the four orientations (90 degrees apart) for the bottle in position on the base 112; with four magnets 180 present in the neck 154 at 90 degree intervals, two of the magnets 180 will be adjacent both sensors 184a, 184b irrespective of which of the four orientations the bottle 118 may take.

Also, the sensors 184a, 184b and magnets 180/280 can act as an “interlock” that prevents unwanted operation/dispensing. Similar to that discussed above, the machine 110 may be configured so that at least one sensor (the sensor 184b) must detect a magnet 180, 280 before the controller 144 permits the machine 110 to operate.

It should also be noted that the presence of the skirt 188 can prevent a user from getting his fingers caught or pinched by the door 132 when a bottle 118, 218 is in position.

The machine 110 can also act upon pouches of different sizes. A large pouch 270 (see FIG. 23) can be used with the large bottle 218. The large pouch is similar to the pouch 70 of FIG. 13, but is slightly longer, wider and thicker.

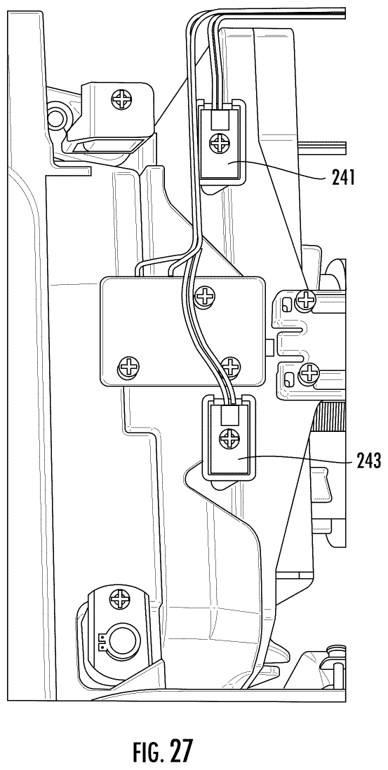

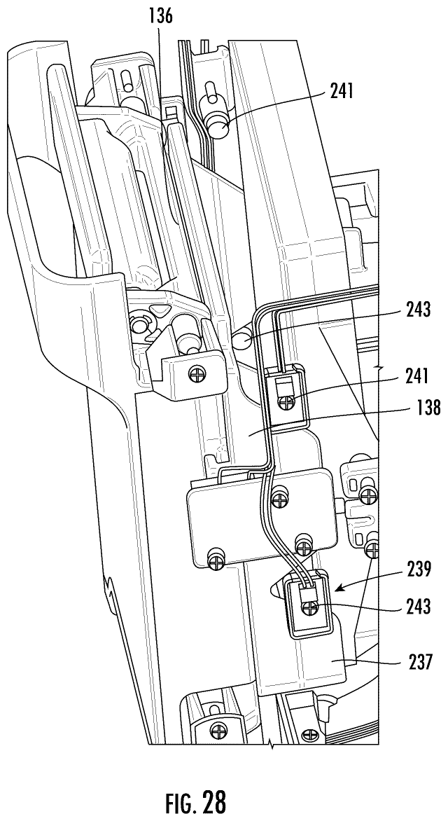

Operation of the machine 110 requires loading of one of the pouches 70 into the pouch chamber 134 as the door 132 is in the open position (FIGS. 22 and 23). The pressing plates 136, 138 are slightly longer than those in the machine 10 to accommodate larger pouches 270. Referring to FIGS. 24-26, it can be seen that the pressing plate 136 includes flanges 237 on each side, with a notch 239 present in each flange 237. A light emitter/sensor pair 241 is mounted above the upper ends of the flanges 237 adjacent each side of the pressing plate 136, and another light emitter/sensor pair 243 is mounted adjacent the notches 239 (see FIGS. 27 and 28). When no pouch is present in the pouch chamber 134 with the door, both sensors 241, 243 detect light emitted by their corresponding emitters 241, 243, which signals the controller 144 that no pouch is present. When a small pouch 70 is inserted into the pouch chamber 134 and the door 132 is moved to the closed position (e.g., FIG. 17), it blocks light of the emitter 243 so that no light is detected by the sensor 243, but the pouch is not large enough to block light emitted by the emitter 241, so the sensor 241 detects light. The controller understands that when light is detected by the sensor 241 by not by the sensor 243, a small pouch 70 is present in the pouch chamber 234. When a large pouch 270 is inserted into the pouch chamber 134 and the door 132 is moved to the closed position, the large pouch 270 is large enough to interfere with the light emitted by both emitters 241, 243, so no light is detected by the sensors 241, 243, thereby indicating to the controller that a large pouch 270 is present in the pouch chamber 234. Thus, the operation of the sensors 241, 243 can ensure that a correctly-sized pouch is matched with a correctly-sized bottle.

Thus, to operate the machine 110, the user opens the door 132 (FIG. 22), inserts a pouch 70, 270 (FIG. 23), and closes the door 132 (e.g., FIG. 17). The user also positions a bottle 118, 218 on the base 116 so that the stirrer 160, 260 engages the clutch hub 120. The user then activates the machine 110 via an activation button on the door 132. The controller receives signals from the sensors 184a, 184b to determine whether a small bottle 118 or a large bottle 218 is present. The controller also receives signals from the sensors 241, 243 to determine whether a large pouch 270 or a small pouch 70 is present in the pouch chamber 134. If the controller determines that the size of the pouch matches the size of the bottle, the controller is then free to activate (a) the piston to compress the pouch in the pouch chamber 134, (b) the motor to rotate the stirrer in the bottle, and (c) the pump or other conveying device to supply water to the bottle through the water nozzle 250. These steps may be performed simultaneously or in a desired sequence. Once dispensing of the contents of the pouch and mixing of those contents with water are completed, the controller deactivates the machine 110, and the user can remove the bottle and affix the lid thereto.

Those of skill in this art will appreciate that either or both of the machines 10, 110 may take other forms. For example, any of the bottles 18, 118, 218 may take a different form (e.g., they may have a different footprint, and/or a different stirring mechanism). The base of either machine 10, 110 may take a different form to accommodate different bottles. The machine 10 may have a continuous water source like the machine 110, or the machine 110 may lack a continuous water source. Other variations, including those discussed in the various documents incorporated by reference herein, may also be employed.

In addition, the employment of the magnets within the neck of the bottle as an interlock mechanism may vary. For example, the sensors that detect the magnets may take a form other than Hall sensors. As another example, the magnets may be placed elsewhere in the bottle (e.g., near the bottom of the bottle), with the sensors being positioned accordingly to sense the magnets. The controller may be configured so that the user can override the interlock. Other variations may also be possible.

Further, the machine 110 may include a different pouch size-detection scheme. As one example, proximity switches (rather than light emitter-detector pairs) may be employed, as may mechanical switches, either of which may follow the same logic scheme for detecting large pouch/small pouch/no pouch within the pouch chamber. Other variations may also be employed.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination. Many variations and modifications can be made to the embodiments without substantially departing from the principles described herein. All such variations and modifications are intended to be included herein within the scope of this disclosure.

That which is claimed is:

1. A bottle for a beverage mixing machine, comprising:
a floor;
at least one side wall extending upwardly from the floor; and
a neck extending upwardly from the side wall;
wherein the neck includes at least one magnet at least partially embedded therein.

2. The bottle defined in claim 1, wherein the at least one side wall is four side walls, and wherein the side walls are arranged so that the bottle has a generally square footprint.

3. The bottle defined in claim 1, wherein the at least one side wall is four side walls, and wherein the side walls are arranged so that the bottle has a generally rectangular footprint.

4. The bottle defined in claim 1, wherein the at least one magnet is two magnets, and wherein the two magnets are located diametrically opposite each other.

5. The bottle defined in claim 1, wherein the at least one magnet is four magnets, and wherein the four magnets are located at approximately 90 degree intervals about the neck.

6. The bottle defined in claim 1, further comprising a lid that fits over the neck.

7. The bottle defined in claim 1, further comprising a rotatable stirrer rotatably mounted to the floor.

8. The bottle defined in claim 1, further comprising a ring indicator that encircles the neck of the bottle, the ring indicator including indicia configured to indicate a parameter regarding the contents of the bottle.

9. A beverage mixing machine, comprising:
a base;
a tower extending upwardly from the base, the tower including a main portion and an overhanging portion;
a dispensing outlet located in the overhanging portion;
one or more sensors located near the dispensing outlet, the one or more sensors configured to detect the presence of a magnet;
a controller mounted in one of the base and the tower, the controller operatively connected with the sensors, the controller configured to prevent operation of the machine unless at least one of the one or more sensors detect the presence of a magnet.

10. The machine defined in claim 9, further comprising a rotatable clutch hub mounted in the base beneath the dispensing outlet, and a motor operatively connected with the clutch hub and with the controller, and wherein the controller is configured to prevent activation of the motor unless the one or more sensors detect the presence of a magnet.

11. The machine defined in claim 9, further comprising:
a pouch chamber fluidly connected with the dispensing outlet, the pouch chamber at least partially defined by first and second pressing plates; and
a piston mounted in the tower connected with the first pressing plate and operative connected with the controller, the piston configured to press the first pressing plate toward the second pressing plate to compress a pouch contained therein, thereby causing contents of the pouch to be dispensed out of the dispensing outlet;
wherein the controller is configured to prevent activation of the piston unless the one or more sensors detect the presence of a magnet.

12. The machine defined in claim 9, wherein the at least one sensor is one sensor.

13. The machine defined in claim 11, wherein the at least one sensor is two sensors, and wherein the two sensors are positioned approximately 90 degrees apart around the dispensing outlet.

14. The machine defined in claim 13, wherein the controller is configured such that the detection of one magnet by the two sensors indicates that a bottle of a first size is present on the base and positioned beneath the dispensing outlet, and such that the detection of two magnets by the two sensors indicates that a bottle of a second size is present on the based and positioned beneath the dispensing outlet, the second size differing from the first size.

15. The machine defined in claim 14, wherein third and fourth sensors are associated with the pouch chamber and are operatively connected with the controller, and wherein the third and fourth sensors are positioned so that a first pouch of a smaller size is detected by only the third sensor, and a second pouch of a larger size is detected by both the third and fourth sensors.

16. A beverage mixing machine, comprising:
a base;
a tower extending upwardly from the base, the tower including a main portion and an overhanging portion;
a pouch chamber with a dispensing outlet located in the overhanging portion, the pouch chamber at least partially defined by first and second pressing plates;
a piston mounted in the tower that engages the first pressing plate, the piston configured to move the first pressing plate toward the second pressing plate to squeeze contents of a pouch residing in the pouch chamber through the dispensing outlet
first and second sensors located adjacent the pouch chamber at, respectively, first and second heights, the first and second sensors configured to detect the presence of a pouch in the pouch chamber;
a controller mounted in one of the base and the tower, the controller operatively connected with the first and second sensors and the piston, the controller configured to prevent activation of the piston if the first and second sensors detect a pouch of an incorrect size.

17. The beverage mixing machine defined in claim 16, wherein the controller is configured such that, if both the first and second sensors detect a pouch, the controller understands that a large pouch is present in the pouch chamber, and if the first pouch detects a pouch but the second sensor does not detect a pouch, the controller understands that a small pouch is present in the pouch compartment.

18. The beverage mixing machine defined in claim 17, wherein the second pressing plate includes a flange on each side edge, wherein a notch is present in each flange, wherein the first sensor operates by shining light through the notches, and wherein the second flange operates by shining light above the flanges.

19. The beverage mixing machine defined in claim 16, further comprising one or more sensors located near the dispensing outlet, the one or more sensors configured to detect the presence of a magnet.

20. The machine defined in claim 19, wherein the at least one sensor is two sensors, and wherein the two sensors are positioned approximately 90 degrees apart around the dispensing outlet.

21. The machine defined in claim 20, wherein the controller is configured such that the detection of one magnet by the two sensors indicates that a bottle of a first size is present on the base and positioned beneath the dispensing outlet, and such that the detection of two magnets by the two sensors indicates that a bottle of a second size is present on the based and positioned beneath the dispensing outlet, the second size differing from the first size.
